(19) United States
(12) Patent Application Publication
(10) Pub. No.: US 2026/0368047 A1
(43) Pub. Date: Nov. 19, 2026

(54) IMPLEMENTING SYSTEM FAILOVER TO ISOLATE DISTRESS

(71) Applicant: International Business Machines Corporation, Armonk, NY (US)

(72) Inventors: Andrew C. M. HICKS, Highland, NY (US); Patrick James MEANEY, Poukeepsie, NY (US); Michael E. GILDEIN, Wappingers Falls, NY (US); Christopher V. DEROBERTIS, Hopewell Junction, NY (US); Ryan Thomas RAWLINS, New Paltz, NY (US)

(21) Appl. No.: 18/631,907

(22) Filed: Apr. 10, 2024

(51) Int. Cl. G06F 11/20

(52) U.S. Cl. CPC G06F 11/2023; G06F 2201/85

(57) ABSTRACT

Embodiments herein describe techniques for implementing soft system failover to isolate distress in a primary computing system using software tools. Embodiments of the present disclosure provide methods, systems, and computer program products for implementing soft system failover to isolate distress in a primary computing system. A disclosed embodiment includes monitoring, on a primary system, event data, where the event data comprise one or more of sensor, metric, or error data; detecting a data anomaly based on the event data, and triggering a soft system failover of a workload on the primary system onto a secondary system. In addition, event data are monitored on the secondary system based on the soft system failover of the workload; and the monitored event data of the primary system and the secondary system are compared to determine whether an environmental characteristic or a physical characteristic of the primary system caused the data anomaly.

### BACKGROUND

The present invention relates to the data processing field, and more specifically, to methods, systems, and computer program products for implementing system failover to isolate distress in a computing system.

Isolating the cause of distress, partially failing, failures, and abnormal operations in a physical system or primary system remains challenging. Isolating components, environmental concerns, and/or workload to identify the cause of distress or system performance issues is tedious, very time-consuming, and often untenable given the number of experiments needed and potential system performance impact. A need exists for enhanced systems and techniques for monitoring, identifying, and isolating distress in a primary system, and determining whether an environmental characteristic or a physical characteristic of the primary system caused the distress.

### SUMMARY

Embodiments of the present disclosure provide methods, systems, and computer program products for implementing soft system failover to isolate distress in a computing system.

According to one embodiment of the present disclosure, a non-limiting computer implemented method is provided. The method comprises monitoring, on a primary system, event data, where the event data comprise one or more of sensor, metric, or error data; detecting a data anomaly based on the event data, and triggering a soft system failover of a workload on the primary system onto a secondary system; monitoring on the secondary system, event data, based on the soft system failover of the workload; and comparing the monitored event data of the primary system and the secondary system to determine whether the data anomaly was caused by an environmental characteristic or a physical characteristic of the primary system.

According to one embodiment of the present disclosure, a system is provided. The system includes one or more computer processors, and a memory containing a program which when executed by the one or more computer processors performs an operation. The operation comprises monitoring, on a primary system, event data, where the event data comprise one or more of sensor, metric, or error data; detecting a data anomaly based on the event data, and triggering a soft system failover of a workload on the primary system onto a secondary system; monitoring on the secondary system, event data, based on the soft system failover of the workload; and comparing the monitored event data of the primary system and the secondary system to determine whether the data anomaly was caused by an environmental characteristic or a physical characteristic of the primary system.

According to one embodiment of the present disclosure, a computer program product is provided. The computer program product includes a computer-readable storage medium having computer-readable program code embodied therewith, the computer-readable program code executable by one or more computer processors to perform an operation. The operation comprises monitoring, on a primary system, event data, where the event data comprise one or more of sensor, metric, or error data; detecting a data anomaly based on the event data, and triggering a soft system failover of a workload on the primary system onto a secondary system; monitoring on the secondary system, event data, based on the soft system failover of the workload; and comparing the monitored event data of the primary system and the secondary system to determine whether the data anomaly was caused by an environmental characteristic or a physical characteristic of the primary system.

### BRIEF DESCRIPTION OF THE DRAWINGS

FIG. 1 is a block diagram of an example computer environment for use in conjunction with one or more disclosed embodiments;

FIG. 2 is a block diagram of an example computing system for implementing soft system failover to isolate distress in a computing system of one or more embodiments of the present disclosure;

FIGS. 3A, 3B, and 3C, together provide a flow chart of example operations of a method for implementing soft system failover to isolate distress of one or more disclosed embodiments;

FIG. 4 is a flow chart illustrating example processing operations of a soft system failover of a method for implementing system failover to isolate distress of one or more disclosed embodiments; and

FIG. 5 is a flow chart of a method for implementing soft system failover to isolate distress of one or more disclosed embodiments.

### DETAILED DESCRIPTION

Embodiments herein describe techniques for implementing system failover to isolate distress in a primary computing system. Disclosed techniques include monitoring event data on a primary system, detecting data anomalies based on the event data, and triggering a soft system failover of a workload on the primary system onto a secondary system. Techniques are described for mirroring, and/or replaying the workload, both data and instructions, on alternate physical resources of the secondary system, and monitoring the event data on the secondary system. The monitored event data of the primary system and the secondary system are compared to determine whether a data anomaly was caused by an environmental characteristic or a physical characteristic of the primary system. The isolation of the data anomaly to an environmental characteristic or a physical system characteristic enables efficient and effective corrective actions.

According to an aspect of disclosed embodiments, a non-limiting computer implemented method is provided. The computer-implemented method comprises monitoring, on a primary system, event data, where the event data comprise one or more of sensor, metric, or error data; detecting a data anomaly based on the event data, and triggering a soft system failover of a workload on the primary system onto a secondary system; monitoring on the secondary system, event data, based on the soft system failover of the workload; and comparing the monitored event data of the primary system and the secondary system to determine whether the data anomaly was caused by an environmental characteristic or a physical characteristic of the primary system. The method enables effective and efficient identification and isolation of system issues, such as at least one of distress, partially failing, or a pattern of degradation over time, and determining whether an environmental characteristic or a physical characteristic for the primary system caused the data anomaly.

According to an aspect of disclosed embodiments, a system is provided. The system includes one or more computer processors, and a memory containing a program which when executed by the one or more computer processors performs an operation. The operation comprises monitoring, on a primary system, event data, where the event data comprise one or more of sensor, metric, or error data; detecting a data anomaly based on the event data, and triggering a soft system failover of a workload on the primary system onto a secondary system; monitoring on the secondary system, event data, based on the soft system failover of the workload; and comparing the monitored event data of the primary system and the secondary system to determine whether the data anomaly was caused by an environmental characteristic or a physical characteristic of the primary system. The system enables effective and efficient identification and isolation of system issues, such as at least one of distress, partially failing, or a pattern of degradation over time, and determining whether an environmental characteristic or a physical characteristic for the primary system caused the data anomaly.

According an aspect of disclosed embodiments, a computer program product is provided. The computer program product includes a computer-readable storage medium having computer-readable program code embodied therewith, the computer-readable program code executable by one or more computer processors to perform an operation. The operation comprises monitoring, on a primary system, event data, where the event data comprise one or more of sensor, metric, or error data; detecting a data anomaly based on the event data, and triggering a soft system failover of a workload on the primary system onto a secondary system; monitoring on the secondary system, event data, based on the soft system failover of the workload; and comparing the monitored event data of the primary system and the secondary system to determine whether the data anomaly was caused by an environmental characteristic or a physical characteristic of the primary system. The computer program product enables effective and efficient identification and isolation of system issues, such as at least one of distress, partially failing, or a pattern of degradation over time, and determining whether an environmental characteristic or a physical characteristic for the primary system caused the data anomaly.

Additionally, an embodiment of the present disclosure further comprises based on determining the data anomaly was not caused by the environmental characteristic or the physical characteristic of the primary system, stop monitoring the event data on the secondary system to end the soft system failover; and continue monitoring the plurality of event data on the primary system. This embodiment enables effectively determining primary system issues causing a data anomaly on the primary system.

Additionally, in an embodiment of the present disclosure, the secondary system comprises a subset of the primary system. This embodiment enables effectively determining primary system issues causing a data anomaly on the primary system, and triggering a soft system failover of a workload on the primary system onto the secondary system.

Additionally, an embodiment of the present disclosure, where triggering the soft system failover of the workload of the primary system onto the secondary system further comprises identifying configuration data for the soft system failover; and replaying the workload of the primary system on the secondary system based on the configuration data; wherein the monitoring on the secondary system further comprises monitoring the event data of the replayed workload. This embodiment enables effectively determining primary system issues causing a data anomaly on the primary system.

Additionally, in an embodiment of the present disclosure replaying the workload of the primary system on the secondary system further comprising replaying the workload for a configured time interval; and mirroring one or more ongoing workloads of the primary system in real-time on the secondary system. This embodiment enables effectively determining primary system issues causing a data anomaly on the primary system.

Additionally, in an embodiment of the present disclosure, triggering the soft system failover of the workload of the primary system onto the secondary system further comprises identifying configuration data for the soft system failover; and mirroring the workload of the primary system on the secondary system based on the configuration data for soft system failover.This embodiment enables effectively determining primary system issues causing a data anomaly on the primary system.

Additionally, in an embodiment of the present disclosure, where the mirroring further comprises restarting the workload on the primary system and begin mirroring the workload on the secondary system with the restarting the workload on the primary system. This embodiment enables effectively determining primary system issues causing a data anomaly on the primary system.

Additionally, in an embodiment of the present disclosure where the mirroring further comprises start mirroring the workload of the primary system onto the secondary system from a state of the primary system where detecting the data anomaly occurred. This embodiment enables effectively determining primary system issues causing a data anomaly on the primary system.

Additionally, in an embodiment of the present disclosure where triggering the soft system failover of the workload of the primary system onto the secondary system further comprises identifying configuration data for the soft system failover, where the configuration data comprises at least one of user specified configuration and control data; and system configuration data; and restart processing at a beginning of a batch workload on the primary system based on detecting the data anomaly; and start mirroring the batch workload of the primary system on the secondary system at the beginning of the restart batch workload processing on the primary system based on the configuration data. This embodiment enables effectively determining primary system issues causing a data anomaly on the primary system.

Additionally, an embodiment of the present disclosure further comprises performing a predefined corrective action, based on the data anomaly caused by the environmental characteristic or the physical characteristic of the primary system; switching designations of the primary system and the secondary system; and continue monitoring the event data on the primary system, This embodiment enables effectively determining primary system issues causing a data anomaly on the primary system.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

In the following, reference is made to embodiments presented in this disclosure. However, the scope of the present disclosure is not limited to specific described embodiments. Instead, any combination of the following features and elements, whether related to different embodiments or not, is contemplated to implement and practice contemplated embodiments. Furthermore, although embodiments disclosed herein may achieve advantages over other possible solutions or over the prior art, whether or not a particular advantage is achieved by a given embodiment is not limiting of the scope of the present disclosure. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment ("CPP embodiment" or “CPP”) is a term used in the present disclosure to describe any set of one, or more, storage media (also called "mediums") collectively included in a set of one, or more, storage devices that collectively include machine readable code corresponding to instructions and/or data for performing computer operations specified in a given CPP claim. A "storage device" is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits / lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

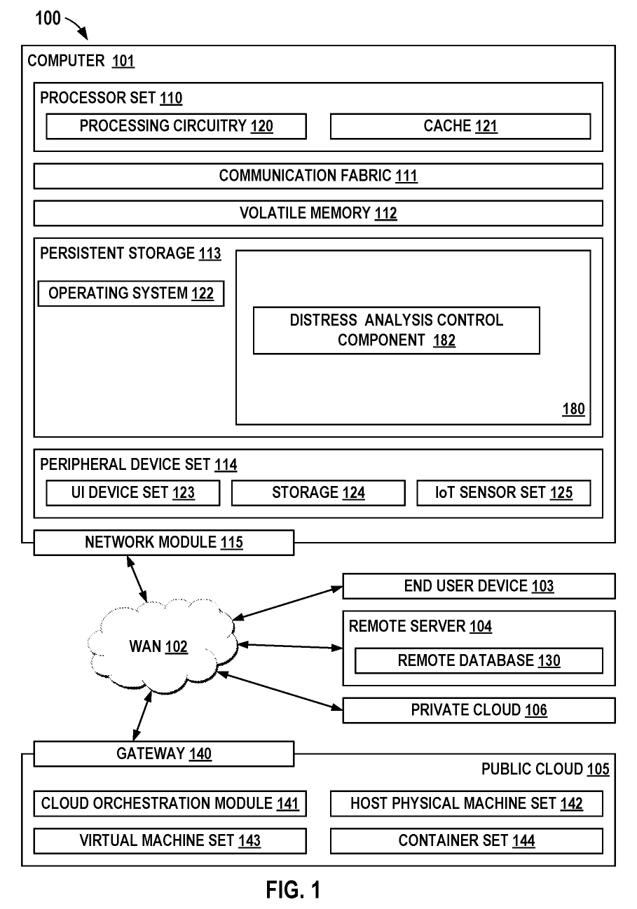

Referring to FIG. 1, a computing environment 100 contains an example of an environment for the execution of at least some of the computer code involved in performing the inventive methods, such as a Distress Analysis Control Component 182, at block 180. In addition to block 180, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 180, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 180 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input / output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 180 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Embodiments of the present disclosure provide methods, systems, and computer program products for implementing soft system failover to isolate distress in a primary computing system. Disclosed embodiments provide enhanced techniques for monitoring and identifying data anomalies, replicating or replaying workload, both data and instructions, on alternate physical resources, and comparing event data monitored on the primary system and secondary system for enabling appropriate corrective action. Disclosed embodiments detect a data anomaly based on the event data, which includes one or more of sensor, metric, or error data, such as chip temperature, current data, and log event historical data that tracks error messages. In an embodiment, detecting the data anomaly triggers a soft system failover of a workload on the primary system to one or more secondary systems, such as defined secondary disaster recovery systems. In an embodiment, the soft system failover includes mirroring the workload and transactions of the primary system on the secondary system. In addition, the soft system failover can replay workload and transactions of the primary system on the secondary system, instead of or in addition to mirroring in real time, to enable isolation of other factors in the system. In a disclosed method, in one embodiment of the soft system failover, the event data are monitored on the secondary system, based on the soft system failover of the workload, and the event data of the primary system and the secondary system are compared to determine if an observed data anomaly resulted from an environmental characteristic, or a physical characteristic of the primary system. In an embodiment, the isolation of the data anomaly to an environmental characteristic or a physical system characteristic efficiently enables effective corrective actions, such as a permanent failover of the primary system to the secondary system, when needed; (e.g., with the primary system exhibiting failure of hardware and/or software) and the secondary system exhibits effective performance characteristics, (e.g., reduced error counts or reduced temperature once normalized).

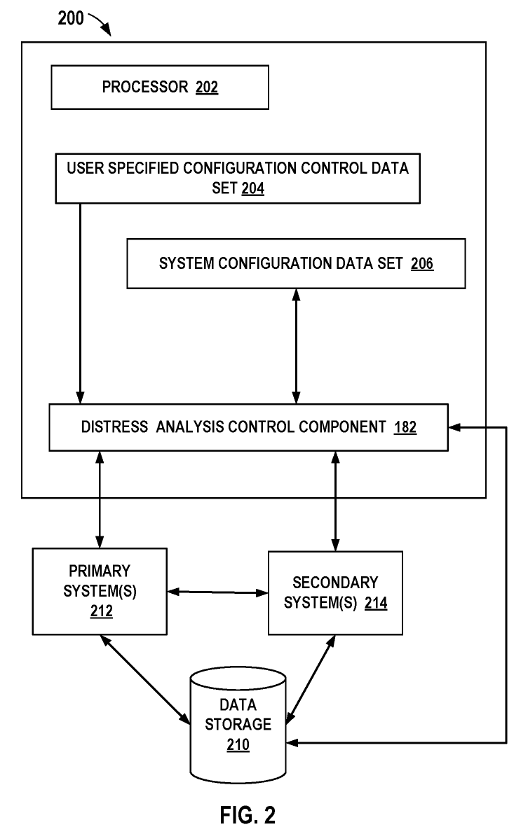

FIG. 2 illustrates an example system 200 for implementing system failover to isolate distress in a computing system of one or more disclosed embodiments. System 200 can be used in conjunction with the computer 101 and cloud environment of the computing environment 100 of FIG. 1 with the Distress Analysis Control Component 182 for implementing system distress isolation of disclosed embodiments. In a disclosed embodiment, system 200 triggers a soft system failover of disclosed embodiments from a primary system 212 to a secondary system 214 upon detection of a data anomaly on a primary system enabling event data monitoring on the secondary system 214, and analysis of the monitored data from the primary system 212 and the secondary system 214, to isolate system distress resulting from an environmental characteristic or issue or a physical system characteristic of the primary system 212. In an embodiment, the soft system failover includes monitoring the event data on the secondary system, based on the soft system failover of the workload, and comparing the event data of the primary system 212 and the secondary system 214 to determine whether the data anomaly was caused by an environmental characteristic, or a physical characteristic of the primary system 212. The isolation of the data anomaly to an environmental characteristic or a physical system characteristic of disclosed embodiments enables efficiently implementing effective corrective actions.

In a disclosed embodiment, the primary system 212 and the secondary system 214 are part of a distributed computer system where multiple software components are included on multiple computing systems that can run as a single computer system. The primary system 212 and the secondary system 214 can be physically close together and connected by a local network, or they can be geographically distant and connected by a wide area network. The primary system 212 and the secondary system 214 can be implemented by various configurations and computer systems, such as mainframe computer, server computer, and the like. In an embodiment, the secondary system 214 comprises a subset of the primary system 212, where the secondary system can include a different processor, memory allocation, node, or drawer of the primary system. For example, where in a multiple-core primary system with a bad processing core, the secondary system 214 can run a workload on a different core of the same primary system, or with a different memory allocation of the primary system.

In a disclosed embodiment, system 200 includes one or more processors 202. System 200 includes a user specified configuration and control data set 204, (e.g., storing configuration and control data specified by the user), and a system configuration data set 206 (e.g., storing configuration data specified by a system administrator or system programmer based on a given primary system 212 and a given secondary system 214, and updated by the Distress Analysis Control Component 182 in accordance with disclosed embodiments). The user specified configuration and control data set 204 and the system configuration data set 206 are used together for configuring and controlling operations of the disclosed distress monitoring methods implemented by system 200. In an embodiment, the user specified configuration and control data set 204 and the system configuration data set 206 are used for monitoring event data including an individual data set, or with various combinations of monitored data sets of monitored sensor, metrics, and error data, to identify and isolate system distress. For example, the monitored event data incudes hardware and system metrics such as temperature, network, input/output (I/O), memory, voltage, system performance (e.g. bandwidth, latency, throughput, and the like), error counts, electromagnetic fields (EMFs), power usage, and the like.

System 200 includes a data storage 210 for storing real-time monitored event data, and storing monitored event data over defined time intervals, or monitored historical event data, of a primary system 212, and a secondary system 214. The data storage 210 stores the monitored event data and monitored event historical data, where the event data includes one or more of real-time and historical sensor, metric, and error data of disclosed embodiments. In a disclosed embodiment, the data storage 210 stores monitored historical data representing error data, statistics, and metrics tracked over time, such as over a defined time interval, for example used for analysis and evaluation of detected data anomalies, and system performance of the monitored primary and secondary physical computing systems 212, 214.

In a disclosed embodiment, the monitored event data includes one or more of chip temperature, current data, workload and/or transaction data, error log data, and event historical data. In an embodiment, the error log data, and event historical data includes a rolling average of recoverable errors over a given time interval. In operation of system 200, instructions and data of the workload and/or transactions can be replayed, instead of, or in addition to being mirrored in real-time, enabling the isolation of multiple distress issues or distress factors in the primary system 212. For instance, system 200 can replay an entire set of long running workloads on the secondary system 214 and mirror ongoing short workloads in order to replicate the workload more accurately at a system level.

In a disclosed embodiment, system 200 uses event data of the data storage 210, which stores monitored event data of the primary system 212 that are analyzed to detect a data anomaly and to trigger a soft system failover on a secondary system 214. In an embodiment, system 200 triggers the soft system failover, based on a detected anomaly, for example, based on detecting a sensor temperature exceeding a configured temperature threshold, determining there is an anomalous value of a given event data, or a rolling average increase in recoverable errors on the primary system. Typically, traditional failover arrangements focus on retrying and recovering from issues of a primary system on one or more secondary systems, or using secondary systems for workload balancing. In disclosed embodiments, system 200 uses the secondary system 214 to mirror workloads and compare selected metrics across the physical primary and secondary systems 212, 214 to determine if an observed anomaly or distress is an environmental issue or physical issue of the primary system 212, (e.g., observed anomaly or distress of the physical system, component, or system configuration of the primary system 212). In disclosed embodiments, system 200 identifies a cause of distress, issues or problems of primary system 212 as an environmental issue, or physical configuration issue, based upon comparing monitored data on the primary system 212 and the secondary system 214 (or multiple secondary systems 214). In an embodiment, system 200 detects data anomalies based on comparing event data of a primary system 212, or a secondary system 214) against itself to create a baseline for comparison and analysis. In an embodiment, system 200 updates the system configuration data set 206 in response to deploying, moving, cancelling, retrying, or taking other actions on the primary system 212 or the secondary system 214 (e.g., implemented by the Distress Analysis Control Component 182 of disclosed embodiments).

For example, in a disclosed embodiment, consider a given system 200 including two identical Central Electronics Complexes (CECs), (e.g., each CEC including at least one primary system 212 or a secondary system) in a datacenter located next to each other and a third CEC in a remote site. For example, if a problem is only experienced on one of the primary system 212 and not the secondary system 214 in the CECs of the same datacenter site, then the problem is more likely a physical issue, whereas if the problem is experienced on both CECs in the same datacenter and not the remote site, then it is more likely to be an environmental issue.

In an embodiment, system 200 can run workloads in a mirrored setup on the primary and secondary systems 212, 214, or workload and/or transactions can be replayed, instead of, or in addition to being mirrored in real-time, based on stored user specified configuration and control data set 204, and system configuration data set 206 for the soft system failover. In a disclosed embodiment, system 200 alternates systems designations of a primary system 212 and a secondary system 214 for monitoring event data and detecting a data anomaly and analyzing monitored event data for the alternated primary and secondary systems 212, 214.

In one disclosed embodiment, system 200 triggers the soft system failover, where workload mirroring of the primary system 212 is implemented on the secondary system 214, and system 200 monitors event data on the secondary system 214. Monitored event data (e.g., comprising sensor, metrics, and/or error data) across the physical primary system 212 and one or more secondary systems 214 stored in the data storage 210 are used for comparison and evaluation of the primary system 212 of disclosed embodiments. System 200 analyzes the real-time and monitored historical event data from the primary system 212 and the secondary system 214 to determine, for the identified data anomaly on the primary system 212, whether an issue or problem of the primary system 212 such as an environmental characteristic or a physical characteristic of the primary system 212. The monitored event data reflects physical system characteristics to isolate physical distress and issues as well as physical environmental impacts, which can also include software metrics. In the case of use of software metrics where two systems 212, 214 are configured for monitoring the same event data with the soft system failover, system 200 efficiently compares metrics of monitored event data for isolating a physical, environmental or system impact on a specified workload.

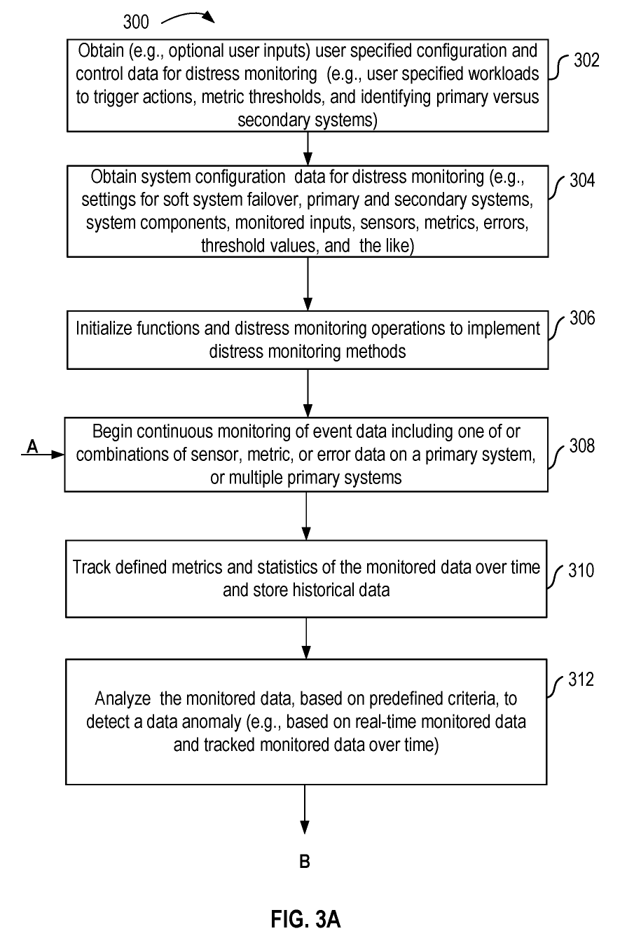

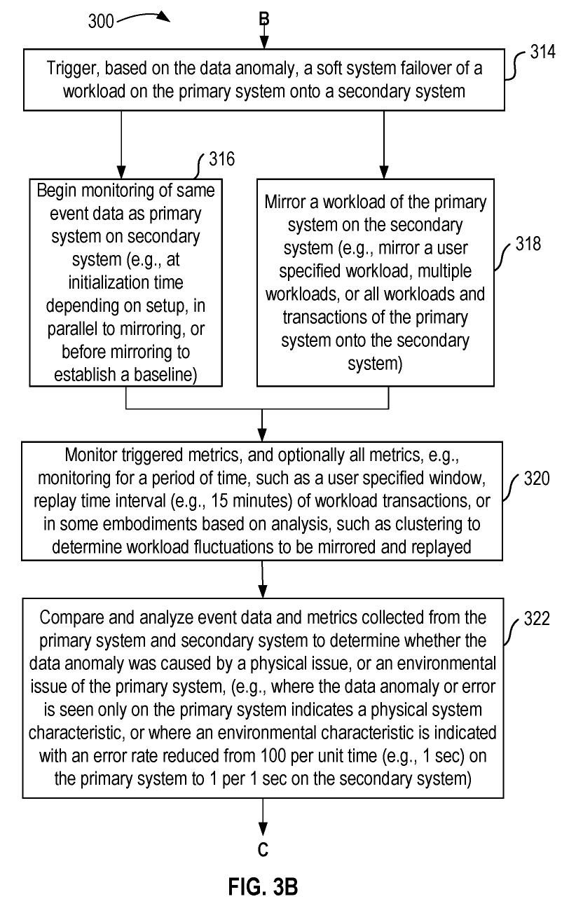

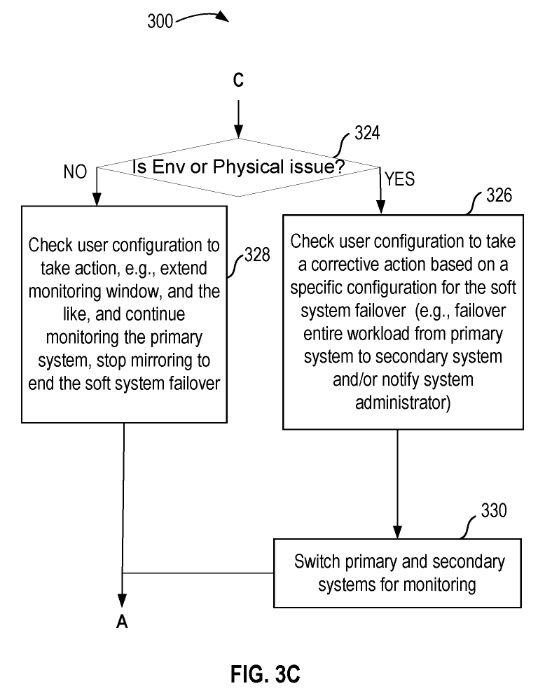

FIGS. 3A and 3B, illustrate example operations of a method 300 for implementing system failover to isolate distress of one or more disclosed embodiments. Method 500 can be implemented by system 200 in conjunction with the Distress Analysis Control Component 182, the computer 101 and cloud environment of the computing environment 100 of FIG. 1 of disclosed embodiments.

At block 302, system 200 obtains (e.g. optional user inputs) user specified configuration and control data set 204 to implement disclosed distress monitoring methods. For example, system obtains user specified workloads to trigger actions, metric thresholds, and user inputs identifying primary versus secondary systems (e.g., stored in user specified configuration and control data set 204 at block 302. At block 304, system 200 obtains system configuration data set 206 for disclosed distress monitoring methods. For example, the system configuration data set 206 includes settings for soft system failover, primary and secondary systems, system components, monitored inputs, sensors, metrics, errors, threshold values and the like. At block 306, system 200 initializes functions and distress monitoring operations to implement distress monitoring methods of disclosed embodiments.

In an embodiment, system 200 performs distress monitoring operations of event data to identify a data anomaly in accordance with disclosed embodiments. In an embodiment, system 200 detects data anomalies based on comparing event data of a system (e.g., primary system 212, and secondary system 214) against itself to create a baseline for comparison and analysis. In an embodiment, system 200 performs event data monitoring and analysis using multiple suitable implementations of system 200, primary system 212, and secondary system 214. For example, analysis can be performed utilizing various implementations of hardware, software, statistical analysis, machine learning and artificial intelligence (AI).

At block 308, system 200 begins continuous monitoring, on a primary system 212 (or multiple primary systems 212), event data, where the event data comprise one of or combinations of sensor, metric, or error data. For example, system 200 continuously monitors event data on the primary system for example, including hardware and system metrics such as temperature, network, I/O, memory, voltage, system performance (e.g. bandwidth, latency, throughput, and the like), error count, electromagnetic fields (EMFs), power usage, and the like. At block 310, system 200 tracks defined metrics and statistics of the monitored event data over time and stores historical data. For example, the stored historical metric and statistic data are used with real-time monitored event data for detecting a data anomaly. At block 312, system 200 analyzes the event data, based on predefined criteria, (e.g. the predefined criteria defined by stored configuration and control data sets 204 and 206) to detect a data anomaly. For example, system 200 detects a data anomaly based on the event data and triggers a soft system failover of a workload on the primary system 212 to the secondary system 214, based on user specified configuration and control data. Operations continue at block 314 following entry point B in FIG. 3B.

In FIG. 3B, at block 314, system triggers, based on detecting the data anomaly, a soft system failover of a workload of the primary system 212 onto a secondary system 214. System 200 processes the disclosed soft system failover of the workload of the primary system 212 onto the secondary system 214 based on the user specified configuration and control data set 204 and the system configuration data set 206. For example, the soft system failover can include a single workload, multiple workloads, or all workloads, and transactions running on the primary system 212, that can be mirrored, replayed, or both mirrored and replayed based on a defined configuration for the primary system 212 and secondary system 214 for the soft system failover. At block 316, system 200 optionally begins monitoring the same event data as the primary system 212 on the secondary system 214, for example, at initialization time depending on the defined configuration for disclosed distress monitoring methods, in parallel with mirroring, or before starting mirroring, to establish a baseline. At block 318, system 200 mirrors a workload (e.g., one or multiple workloads and transactions) of the primary system 212 onto the secondary system 214. For example, system 200 optionally mirrors a user specified workload, multiple workloads, or all workloads and transactions of the primary system 212 onto the secondary system 214. In a disclosed embodiment, at block 320, system 200 performs monitoring of triggered metrics (or optionally all metrics), which may occur for a set period of time, such as a user specified time window, for example a set number of minutes (e.g., 15 minutes) of workload transactions. In other disclosed embodiments, the monitoring is based on performing analysis, such as clustering to determine workload fluctuation to be mirrored and replayed.

At block 322, system 200 compares and analyzes event data and metrics of the monitored event data, comparing event data of the primary system 212 and the secondary system 214 to determine whether the data anomaly or error was caused by a physical issue or an environmental issue of the primary system 212. For example, where the data anomaly is seen only on the primary system 212 indicates a physical issue of the primary system 212, and while an environmental characteristic of the primary system 212 is indicated as causing the data anomaly, for example when an error rate is reduced on the secondary system 214, such as from 100 per unit time (1 sec) on the primary system 212 to 1 per 1 sec on the secondary system 214. Operations continue at decision block 324 following entry point C in FIG. 3C.

In FIG. 3C, at decision block 324, system 200 checks if the data anomaly was caused by a physical characteristic or an environmental characteristic of the primary system 212. In an embodiment, system 200 performs a predefined corrective action based on determining an environmental characteristic or a physical characteristic for the primary system 212 caused the data anomaly, switches designations of the secondary system 214 to the primary system 212, and continues monitoring of the primary system 212. Otherwise, monitoring on the secondary system 214 is stopped with the soft failover event ended, and monitoring on the primary system is continued at block 308 in FIG. 3A.

As shown at block 326, when determined that a physical characteristic or an environmental characteristic of the primary system 212 caused the data anomaly, system 200, checks user configuration to take an appropriate (e.g., configured) corrective action based on a specific configuration for of the soft system failover. For example, system 200 can failover the entire workload from the primary system to the secondary system, and/or notify a system administrator or system programmer. At block 328, system 200 switches designations of the primary and secondary systems to continue monitoring. Otherwise, if a physical characteristic and/or an environmental characteristic is not identified; at block 330; system 200 checks user configuration to take action, for example, to extend the monitoring window, and the like, and continues monitoring the event data on the primary system 212, and stops mirroring, ending the soft system failover. Operations return to block 308 in FIG. 3A to continue monitoring.

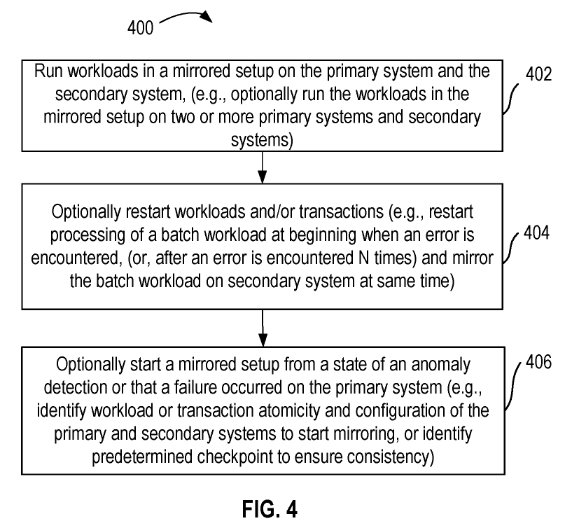

FIG. 4 illustrate example soft system failover processing operations of a method 400 for implementing system failover to isolate distress of one or more disclosed embodiments. Method 400 includes example soft system failover processing operations used in the method 300 of disclosed embodiments.

At block 402, system 200 runs the workloads in a mirrored setup on the two primary and secondary systems 212, 214 or more systems 212, 214, which may or may not be running in tandem. For instance, an available system load balancer or system workload balancer (not shown) can send the transaction, request, and/or job to both the primary and secondary systems 212, 214 at nearly the same time. At block 404, system 200 optionally restarts the workloads and/or transactions to implement the soft system failover. For instance, typically a batch workload restarts processing from the beginning when an error is encountered, or after the N times an error was seen on the primary system 212, and system 200 can mirror that batch workload onto the secondary system 212 at the same time, i.e., at the beginning of the restarted batch workload processing on the primary system 212. At block 406, system 200 optionally starts a mirrored setup from the state that a failure occurred on the primary system 212, or the state of an anomaly detected, on the primary system 212. For instance, if the secondary system 214 is in an appropriate state to start the workload or transaction from the point of the failure, this provides an optimal time for system 200 to start mirroring on the primary system 212 and at least one secondary system 214.

At block 406, system 200 identifies workload or transaction atomicity and configuration of the systems 212, 214 to determine a point to start mirroring of the workload or transaction. For example, in a disclosed embodiment, with an atomic database transaction or a stateless Representational State Transfer (REST) Application Programming Interface (API) call, system 200 can start mirroring much more quickly than a long running backup batch job that would have to wait until restart or a pre-determined checkpoint to ensure consistency. In a disclosed embodiment, an available Workload Management System (WLM) or a load balancer starts sending workloads and/or transactions at the appropriate time to ensure consistency. Where one or more systems 212, 214 have synchronous data and workload executed on each, mirroring can be simply implemented to route the transaction and/or workload to each primary system 212, and secondary system 214.

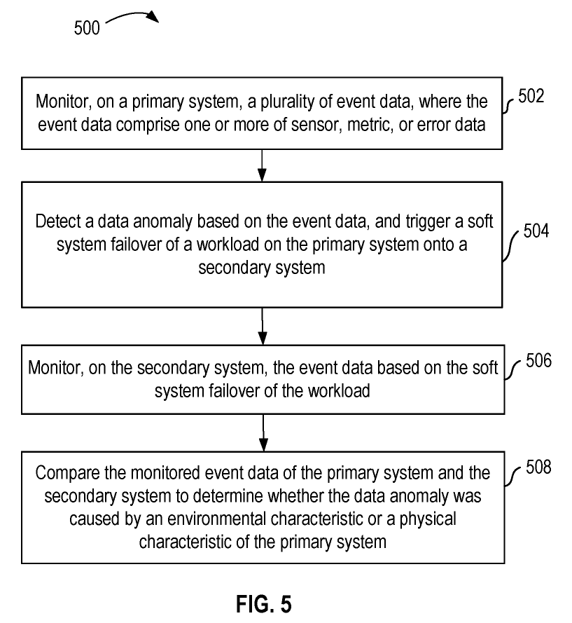

FIG. 5 illustrates example features and operations a method 500 for implementing system failover to isolate distress of one or more disclosed embodiments. Method 500 can be implemented by system 200 in conjunction with the Distress Analysis Control Component 182, the computer 101 and cloud environment of the computing environment 100 of FIG. 1 of disclosed embodiments.

At block 502, system 200 monitors, on a primary system, event data, where the event data comprise one or more of sensor, metric, or error data. For example, as described for blocks 308 and 310 in FIG. 3A, system 200 continuously monitors event data in real-time and tracks defined metrics and statistics of the monitored event data over time, and stores historical event data that is used with the real-time event data to detect a data anomaly. For example, the event data includes At block 504, system 200 detects a data anomaly based on the event data, and triggers, based on the data anomaly, a soft system failover of a workload on the primary system onto a secondary system.

At block 506, system 200 monitors, on the secondary system, the event data, based on the soft system failover of the workload. For example, the event data monitored on the secondary system can include the same event data monitored on the primary system 212, and triggered metrics or all metrics which may occur for a set period of time, such as a user specified time window as described for blocks 316 and 320 in FIG. 3B. At block 508, system 200 compares the monitored event data of the primary system and the secondary system to determine whether the data anomaly was caused by an environmental characteristic or a physical characteristic of the primary system. In an embodiment such as described at block 322 in FIG. 3B, system 200 compares and analyzes event data and metrics of the monitored event data, comparing event data of the primary system 212 and the secondary system 214 to determine whether the data anomaly or error was caused by a physical issue or an environmental issue of the primary system 212.

While the foregoing is directed to embodiments of the present invention, other and further embodiments of the invention may be devised without departing from the basic scope thereof, and the scope thereof is determined by the claims that follow.

What is claimed is:

1. A method comprising:
monitoring, on a primary system, event data, wherein the event data comprise one or more of sensor, metric, or error data;
detecting a data anomaly based on the event data, and triggering a soft system failover of a workload of the primary system onto a secondary system,
monitoring, on the secondary system, the event data, based on the soft system failover of the workload; and
comparing the monitored event data of the primary system and the secondary system to determine whether the data anomaly was caused by an environmental characteristic or a physical characteristic of the primary system.

2. The method of claim 1, wherein the secondary system comprises a subset of the primary system.

3. The method of claim 1, further comprises:
performing a predefined corrective action, based on the data anomaly caused by the environmental characteristic or the physical characteristic of the primary system;
switching designations of the primary system and the secondary system; and
continue monitoring the event data on the primary system.

4. The method of claim 1, wherein triggering the soft system failover of the workload of the primary system onto the secondary system further comprises identifying configuration data for the soft system failover; and replaying the workload of the primary system on the secondary system based on the configuration data; wherein the monitoring on the secondary system further comprises monitoring the event data of the replayed workload.

5. The method of claim 4, wherein replaying the workload of the primary system on the secondary system further comprising replaying the workload for a configured time interval; and mirroring one or more ongoing workloads of the primary system in real-time on the secondary system.

6. The method of claim 1, wherein triggering the soft system failover of the workload of the primary system onto the secondary system further comprises identifying configuration data for the soft system failover; and mirroring the workload of the primary system on the secondary system based on the configuration data for soft system failover.

7. The method of claim 6, wherein the mirroring further comprises restarting the workload on the primary system and begin mirroring the workload on the secondary system with the restarting the workload on the primary system.

8. The method of claim 6, wherein the mirroring further comprises start mirroring the workload of the primary system onto the secondary system from a state of the primary system where detecting the data anomaly occurred.

9. The method of claim 1, wherein triggering the soft system failover of the workload of the primary system onto the secondary system further comprises identifying configuration data for the soft system failover, where the configuration data comprises at least one of user specified configuration and control data, and system configuration data; restarting processing at a beginning of a batch workload on the primary system based on detecting the data anomaly; and starting mirroring the batch workload of the primary system on the secondary system at the beginning of the batch workload processing on the primary system based on the configuration data.

10. The method of claim 1, further comprises:
performing a predefined corrective action, based on the data anomaly caused by the environmental characteristic or the physical characteristic of the primary system;
switching designations of the primary system and the secondary system; and
continue monitoring the event data on the primary system.

11. A system, comprising one or more computer processors; and a memory containing a program which when executed by the one or more computer processors performs an operation, the operation comprising:
monitoring, on a primary system, event data, wherein the event data comprise one or more of sensor, metric, or error data;
detecting a data anomaly based on the event data, and triggering a soft system failover of a workload of the primary system onto a secondary system,
monitoring, on the secondary system, the event data, based on the soft system failover of the workload; and
comparing the monitored event data of the primary system and the secondary system to determine whether the data anomaly was caused by an environmental characteristic or a physical characteristic of the primary system.

12. The system of claim 11, further comprises:
performing a predefined corrective action, based on the data anomaly caused by the environmental characteristic or the physical characteristic of the primary system;
switching designations of the primary system and the secondary system; and
continue monitoring event data on the primary system.

13. The system of claim 11, wherein triggering the soft system failover of the workload of the primary system onto the secondary system further comprises identifying configuration data for the soft system failover; and mirroring the workload on the primary system on the secondary system based on the configuration data for soft system failover.

14. The system of claim 13, wherein the mirroring further comprises restarting the workload on the primary system and begin mirroring the workload on the secondary system with the restarting the workload on the primary system.

15. The system of claim 13, wherein identifying configuration data for the soft system failover further comprises identifying at least one of user specified configuration and control data, and system configuration data.

16. A computer program product comprising a computer-readable storage medium having computer-readable program code embodied therewith, the computer-readable program code executable by one or more computer processors to perform an operation comprising:
monitoring, on a primary system, event data, wherein the event data comprise one or more of sensor, metric, or error data;
detecting a data anomaly based on the event data, and triggering a soft system failover of a workload of the primary system onto a secondary system,
monitoring, on secondary system, the event data, based on the soft system failover of the workload; and
comparing the monitored event data of the primary system and the secondary system to determine whether the data anomaly was caused by an environmental characteristic or a physical characteristic of the primary system.

17. The computer program product of claim 16, further comprises:
performing a predefined corrective action, based on the data anomaly caused by the environmental characteristic or the physical characteristic of the primary system;
switching designations of the primary system and the secondary system; and
continue monitoring the event data on the primary system.

18. The computer program product of claim 16, wherein triggering the soft system failover of the workload of the primary system onto the secondary system further comprises identifying configuration data for the soft system failover; and mirroring the workload on the primary system on the secondary system based on the configuration data for soft system failover.

19. The computer program product of claim 18, wherein the mirroring further comprises restarting the workload on the primary system and begin mirroring the workload on the secondary system with the restarting the workload on the primary system.

20. The computer program product of claim 18, wherein identifying configuration data for the soft system failover further comprises identifying at least one of user specified configuration and control data, and system configuration data.
